(19) United States
(12) Patent Application Publication
(10) Pub. No.: US 2024/0267250 A1
(43) Pub. Date: Aug. 8, 2024

(54) SYSTEM FOR REMOTE APPLIANCE MONITORING

(71) Applicant: GMG Products, LLC, Lakeside, OR (US)

(72) Inventor: David Scott, Glendale, AZ (US)

(21) Appl. No.: 18/106,461

(22) Filed: Feb. 6, 2023

(51) Int. Cl. H04L 12/28

(52) U.S. Cl. CPC H04L 12/2812; H04L 12/2827

(57) ABSTRACT

A system for remotely monitoring an appliance over a network includes an appliance having an appliance controller arranged to collect and send appliance data to a remote client device such as a mobile phone. The state data may include one or more parameters related to an aspect of the appliance, a timestamp, counter, or hash value. At the client device, the state data is compared with previously received state data, such as by comparing one of the parameters. If the state data parameter is different from a previously received parameter, the system concludes that the data is fresh and that the system is operating properly.

### FIELD OF THE INVENTION

This invention relates to remote monitoring and control of appliances, including techniques for determining whether the remote client device is receiving fresh data from the appliance, thus indicating that the system is operating properly.

### BACKGROUND OF THE INVENTION

It is increasingly useful to be able to control appliances or other devices in a remote fashion, such as with a mobile phone or another computerized client device that is not physically connected to the appliance. In some applications, communications might occur over a wireless protocol such as Bluetooth or WiFi, which may impose limits on how far the user can be from the appliance. But in other applications, the mobile phone might use the cellular network or a communications network such as the Internet. In such a configuration, the use of a remote client computer, such as a mobile phone and a tailored mobile application, allows the person to control or interact with the appliance from literally anywhere, regardless of how near or far the person is from the appliance.

In some current systems, developers of remote appliance control systems have believed that it is important for the operator of the mobile device to know whether the appliance is actually connected to the server, and thus that there is a communication link allowing the mobile device to maintain constant control over the appliance. To that end, in some such systems the server performs an analysis to determine whether the appliance is connected to the server, then generates a notification that is sent to the mobile device indicating that the server is connected to the appliance. This is a server-centric model, imposing upon the server the burden of continually confirming whether a connection exists and then generating and sending some sort of report to the mobile device to confirm it.

### SUMMARY OF THE INVENTION

An improved and more elegant solution treats the server as a pass-through device, removing the overhead burden of performing this analysis at the server. Moreover, the operator of the mobile device does not really care about the technical accuracy of whether the appliance is truly connected at any specific moment in time. Instead, the user is satisfied with a simple reassurance that the interaction is in some sense working properly, regardless of whether there is a strictly accurate report of an actual connection at any instant. Accordingly, in the present invention the appliance simply collects and transmits data representative of the state of the appliance. That data is transmitted to the mobile device as-is, passing through the server without performing the additional analytical step of evaluating connectivity status, and without the server adding anything to the data indicative of a connectivity status. The mobile device receives the appliance data, and compares some aspect of the current state data (as generated at the appliance) against the previously-received state data to determine whether the current state data is different from the prior set. If the data is different, it concludes that the system is operating properly because it received a fresh set of data, and may present to the user an indication to that effect.

A system for remotely monitoring an appliance by a client device operating over a network includes an appliance controller coupled to the appliance and arranged for communication with the client device over the network, the appliance controller having an appliance processor and an appliance memory accessible by the appliance processor. The appliance processor is configured to send state data regarding the appliance to the client device over the network, the state data including a parameter. An application program is stored on and operable by the client device to compare a first value of the parameter associated with a first set of state data received at the client device at a first time with a second value of the parameter associated with a second set of state data received at the client device at a second time later than the first time. When the application program determines that the first value of the parameter is not equal to the second value of the parameter, cause a client device display to present a first indicator indicating that the system is operating correctly.

In some versions, the parameter comprises a counter value, a timestamp, or a hash value.

Preferably, the state data contains sufficient entropy to derive or read a unique signature for every packet of state data sent. An example of such a signature is a the bit-by-bit content of the encrypted state data where, for example, the state data is encrypted at the appliance controller prior to transmission to the client device.

In preferred versions, the application program is further configured to cause the client device to present a second indicator when the application program determines that the first value of the parameter is equal to the second value of the parameter, the second indicator indicating that the system is not operating correctly. In some versions, the application program is configured to cause the presentation of the second indicator only after repeated determinations that the first value of the parameter is equal to the second value of the parameter.

Further versions of the invention include a system for remotely monitoring over a network using a client device, including an appliance having an appliance subsystem and an appliance controller. The appliance controller has an appliance processor, an appliance memory accessible by the appliance processor, and a transmitter arranged for communication with the client device over the network. The appliance memory contains stored programming instructions operable by the processor to enable the processor to collect appliance state data, the appliance state data including data regarding the appliance subsystem, and to send the appliance state data via the transmitter to the client device over the network. The state data includes a parameter, which may be an element of the data, or the data itself in a bitwise fashion.

An application program is operable by the client device, which is preferably a mobile phone, to compare a first value of the parameter associated with a first set of appliance state data received at the client device at a first time with a second value of the parameter associated with a second set of appliance state data received at the client device at a second time later than the first time. When the application program determines that the first value of the parameter is not equal to the second value of the parameter, it causes a client device user interface to present a first indicator indicating that the system is operating correctly.

In some versions, the state data is encrypted at the appliance controller prior to transmission to the client device, and the parameter comprises the bit-by-bit content of the encrypted state data.

### BRIEF DESCRIPTION OF THE DRAWINGS

Preferred and alternative examples of the present invention are described in detail below with reference to the following drawings.

FIG. 1 is an illustration of a representative appliance, remote controller, and cloud server.

FIG. 2 is a block diagram of a preferred implementation of a mobile device in accordance with FIG. 1.

FIG. 3A is a block diagram of a preferred implementation of a cloud server in accordance with FIG. 1.

FIG. 3B is a block diagram of an alternative preferred implementation of a cloud server in accordance with FIG. 1.

FIG. 4 is a block diagram of a preferred implementation of an appliance controller in accordance with FIG. 1.

FIG. 5 is a representation of appliance data collected by the appliance and transmitted to the mobile device.

FIG. 6 is a flow diagram of a preferred implementation of the collection and transmission of data from the appliance to the mobile device.

FIG. 7 is a flow diagram of a preferred implementation of the receipt and processing of the data received at the mobile device from the appliance.

### DETAILED DESCRIPTION OF THE PREFERRED EMBODIMENT

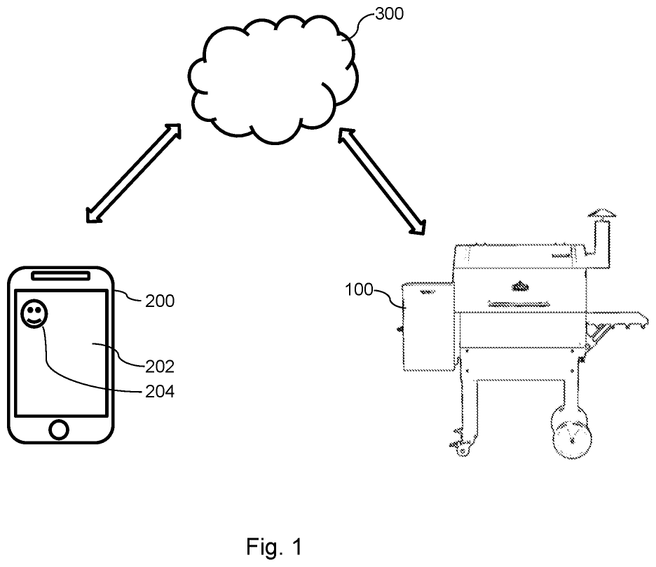

FIG. 1 illustrates a representative appliance 100 in communication with a client device (which may be a mobile device such as a mobile phone) 200 over a network 300. In this case, the appliance 100 is illustrated as a barbeque grill, which may be a pellet-fed smoker or a woodchip-fed smoker, for example. The appliance may take any other forms, such as a refrigerator, coffee maker, furnace, or other. Likewise, though a mobile device 200 is illustrated as a mobile phone, it may alternatively be a desktop computer, tablet computer, or any other computerized device capable of communicating with an appliance in a remote fashion such as shown in FIG. 1. The mobile device includes a display 202, and is capable of presenting on the display a symbol 204 indicating that the system is operating properly. The network 300 is preferably a distributed network, rather than a local area network such as an in-home WiFi. Thus, most preferably it is in the form of the Internet, cellular phone network, or some combination of the two.

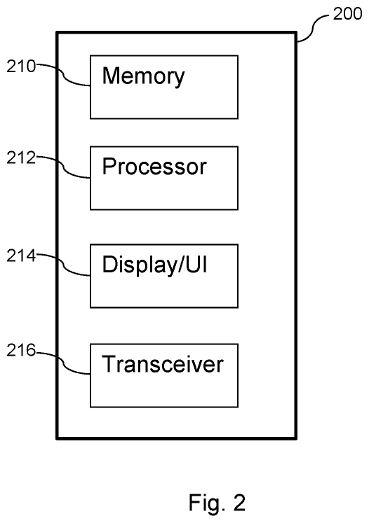

A block diagram of the client device, such as a mobile phone, is shown in FIG. 2. One version of the client device includes an internal memory 210 and processor 212. A transceiver 216 (which may be in the form of a separate transmitter and receiver, and/or optionally one or more antennas) is provided to send and receive RF communications, such as Bluetooth, WiFi or cellular. In addition, or instead, of the transceiver, the client device may include a port for an ethernet or other wired communications connection. The client device includes a display or user interface 214, which is preferably a touch screen allowing the user to both see displayed information and enter commands through the screen. While FIG. 1 shows the client device communicating directly to the network server, it should be appreciated that any number of intermediate devices such as routers, modems, and the like, may be provided to facilitate communication between the client device and the network server. For example, the client device may first communicate locally through a WiFi network, perhaps in a wired fashion using a network or other communications cable, with such communications ultimately being forwarded along to the server. In some examples, there may be several intermediate connections along the way, each of which may be either wired or wireless, or any combination of the two.

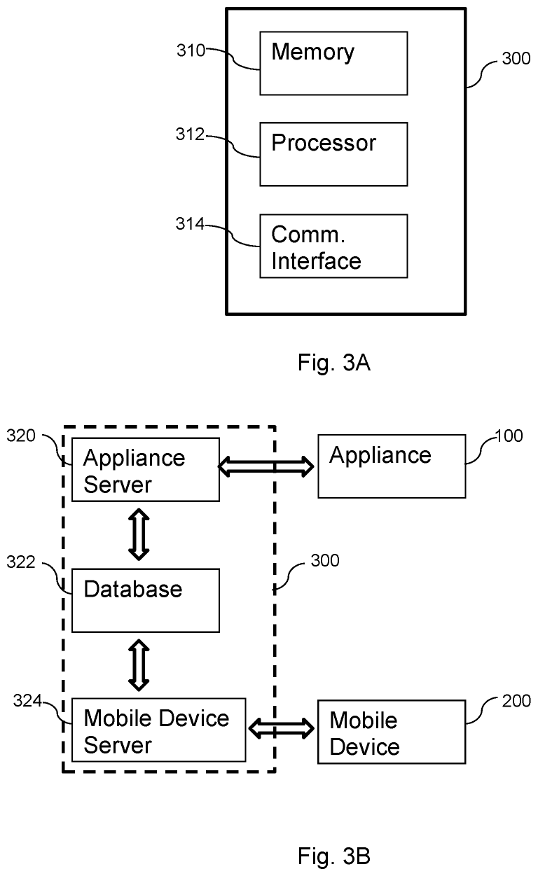

A representative block diagram of a network server is shown in FIG. 3A. In a simple form, a single server includes a memory 310, a processor 312, and a communication interface 314 arranged to allow the server to send and receive messages over the network. Thus, in a simple form the server is a standard network server capable of receiving data transmissions from the appliance and forwarding them along to the client device, as well as receiving transmissions from the client device and sending them to the appliance. The transmissions to the appliance may include, for example, instructions to adjust or maintain a particular temperature, or to turn power on or off.

An alternate server configuration is illustrated in FIG. 3B. In this example, a separate appliance server 320 is arranged to communicate with the appliance 100, while a mobile device server 324 is arranged to communicate with the appliance. A common database 322 temporarily stores data transmissions received at the applicable server from either the mobile device or the appliance, as they are in transit to the other of the appliance or the mobile device.

The arrangement of FIG. 3A may be best suited for a push system, in which data from the grill is pushed to the appliance (and vice versa) without the appliance asking to receive it. The arrangement of FIG. 3B, by contrast, is best suited to a pull or polling system in which data is parked on the server (that is, in the database 322) until either the appliance or the mobile device asks for it. For example, the appliance 100 may send a bundle of state data to the appliance server 320, containing information such as a current temperature of the appliance (when the appliance is, for example, a grill). The appliance server receives the data and stores it in the database 322, without performing any additional analysis on it. The data sits in the database until the mobile device server 324 retrieves it, which it will do upon a request for it by the mobile device. In response to such a request, the mobile device server retrieves the most recently stored set of data (or the only set of data for the applicable appliance, if the old data is simply overwritten with a new set of data each time), and then sends it to the mobile device.

This system allows for any period of time for the polling interval, such as a request by the mobile device every five seconds, or ten seconds, or thirty seconds. In some systems, where the appliance need not be monitored so closely, the polling interval may be a matter of minutes or hours rather than seconds. Meanwhile, the appliance collects and uploads its state data at similar intervals, although the transmission interval by the appliance need not be the same as the polling interval of the mobile device, and need not be aligned in time.

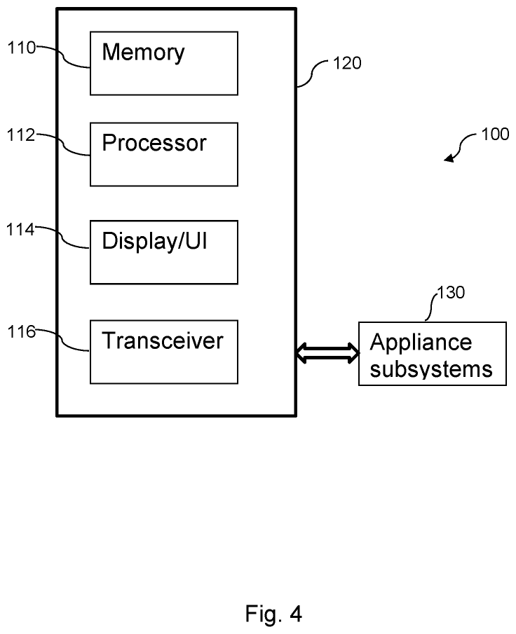

FIG. 4 is a block diagram of a representative appliance 100, such as a grill. In the illustrated example, the appliance includes an appliance controller 120, which is generally a computer controller for operating the appliance and communicating with the server. The appliance controller may include, in some versions, a memory 110 and a processor 112. Most preferably, it includes some form of user interface 114, which may include a display allowing a user to enter commands locally, see information received over the server, or present to the user information about the state of the appliance. The appliance controller also preferably includes a transceiver 116, which may be one or more transmitters and receivers, including an antenna. As with the client device, the appliance controller may alternatively (or in addition) have an ethernet or other wired connection for wired rather than wireless communications, and may send communications through any number of wired or wireless intermediate devices on the way to the network server. The appliance controller interacts with one or more appliance subsystems 130, sending commands and receiving state data from those subsystems. In the case of a grill, the subsystems may include a pellet or wood-chip feed auger, a fuel throttle, one or more temperature probes, a fuel level indicator, and an on-off control. Thus, for example, the appliance controller can obtain the temperature of the grill at one or more probes, can send an instruction to a propane regulator or to a pellet or wood-chip hopper (for example) to increase or decrease fuel rate, or can turn the grill on or off entirely. Similar types of controls apply to other appliances, such as obtaining the temperature of a refrigerator, or the battery level of an appliance, etc.

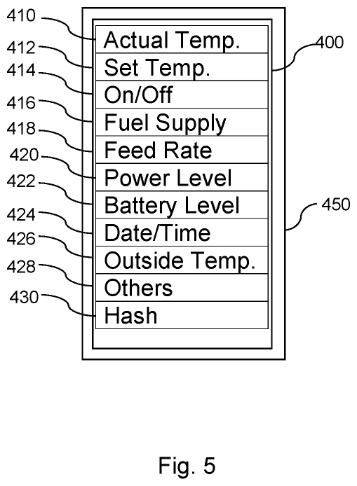

FIG. 5 is a representation of exemplary appliance data 400 collected by the appliance controller and transmitted to the mobile device. In some examples, the data may include a current actual temperature 410, such as a temperature measured by a temperature probe or thermometer located inside the grill or appliance. In the case of an appliance in which the temperature can be controlled by indicating a desired temperature, a set temperature 412 can be entered into the appliance controller memory; thus, the set temperature indicates the temperature the appliance controller is trying to achieve at a particular probe or thermometer. As one example, a user may enter a desired temperature to be achieved for the inside of the appliance, or to be achieved at a probe that may be inserted into food. The data may also include an on/off indicator 414, which may reflect whether the appliance is on or off, and further may be locally or remotely controllable. A fuel supply indicator 416 may reflect a current amount of fuel, such as contained in a tank, reservoir, or hopper. A feed rate indicator 418 may reflect the rate at which fuel (whether gas, pellet, wood, or other) is fed into the appliance. Similarly, a power level indicator 420 may reflect the same thing in a system that is electrically controlled, or may reflect a current state of charge of a battery. In some versions, the appliance includes a real time clock and may apply a timestamp 424 along with the data. Still further, in some versions there is a thermometer which will collect the outside temperature 426 at the appliance.

Yet other data 428 may be collected and stored at the appliance. In one example of “other” data, the appliance controller may implement a counter or a random number generator. In such a system, when the appliance state data is gathered for transmission to the server, a new data counter is produced and bundled with the other state data. As used here, the term “data counter value” means either an incremented counter value, a randomly generated value, a value taken from a table, or any other changing value apart from actual appliance state data. Most preferably, the data counter is unique each time but in other versions that is not necessary. Thus, in some versions the data counter value cycles through some small range, such as counting to eight and then starting over, or simply alternating between two numbers, such as one and zero.

In some instances, it may be desirable to encrypt the bundle of data that is sent from the appliance to the mobile device, as indicated by the encrypted wrapper 450 illustrated in FIG. 5. The use of encryption provides an added layer of security, helping to ensure that third parties cannot access information allowing them to take control of the appliance and cause mischief.

In some versions, the appliance may perform hashing on the set of data (either while unencrypted or after encryption) to produce a hash value 430. A hash value may typically be created to allow the receiving system to verify the integrity of the message it received, but because the hash should be different for each payload of appliance data, the client application can compare a currently received hash against a previously received hash to evaluate whether the currently received data set matches a previously received set. Optionally, in a system employing a hash function, the appliance controller will be programmed to manage hashing collisions, and thus to avoid producing the same hash value for an immediate-subsequent set of data 400.

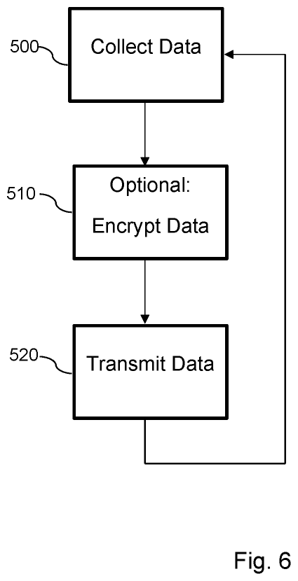

FIG. 6 illustrates a flow diagram of the collection and transmission of data from the appliance. At a first step 500, appliance state data is collected. The state data may include all or a subset of the data described above with reference to FIG. 5, as well as other state data applicable to the particular appliance. In some versions, collecting data includes collecting a data counter value, as described above. In yet other versions, the data counter value optionally is not used, and instead one or more of the variables among the state data is known to vary sufficiently over time such that it is highly unlikely to get the same reading twice. For example, a temperature probe may be used with a value to three or more decimal places, such as 105.356 degrees Fahrenheit. Even though the reading may be very similar a few seconds later (and appear to be identical, if rounded to fewer decimal places), it is unlikely that it will be identical at a given level of precision. Thus, in a subsequent reading it may be, for example, 105.361 degrees.

As yet another alternative, the state data may include a generated entropy value. A processor often includes an integrated generator that can provide a high quality and high speed entropy to the operating system, with entropy being the randomness elected by the operating system or an application, often for use in cryptography. The entropy value is randomly generated by the CPU, often being collected from hardware sources such as variance in a fan noise or a hard drive, or keyboard movements or others. In some cases, a specific entropy generating device may be incorporated. Through these or other techniques, the appliance controller may generate an entropy value, or random number, for use as a component of the state data such as the data indicated by Others 428 in FIG. 5. The entropy value is expected to be random and thus different with each generation of it, and thus the entropy value captured and used for a first collected set of state data will be different from one in a second set of state data.

At a next step 510, optionally, the bundle of collected state data is encrypted. Once assembled and optionally encrypted, at a next step 520 the data is transmitted to the server for subsequent forwarding to the client device. The transmission step 520 may include, in some instances, an intermediate storage of the data at the appliance after assembly and prior to transmission. After the appliance state data is transmitted to the server, it is either stored in the server database temporarily while awaiting a request for it from the client, or is pushed along directly to the client.

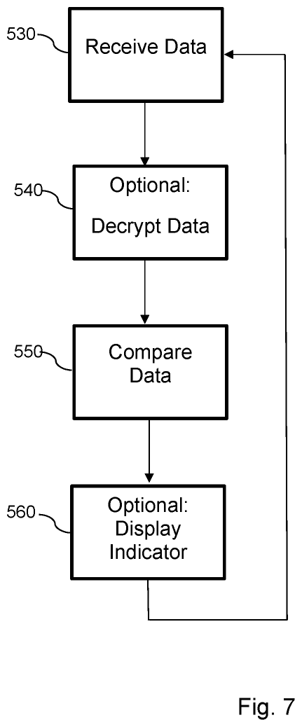

FIG. 7 illustrates a flow diagram of the processing of the data after receipt by the client. At a first step 530, the data is received from the server. In the case of encrypted data, the received data is decrypted at a step 540.

At a next step 550, current data is compared with the prior set of appliance data to determine whether the most recent set of received data is different and thus new. In one version, the client application performs a bitwise comparison of the current encrypted payload against the most recent previously received encrypted payload to determine whether they are either identical or different. This comparison can take place either before or after the decryption; even if decryption occurs first, a copy of the encrypted payload may be retained for the purposes of this comparison. In these versions, the “parameter” being compared is the bitwise content of the encrypted payload, or some related aspect of the payload which is discernible while the payload remains encrypted. Indeed, if the collection of state data contains any unique information as compared to the prior set of collected state data (whether by inclusion of a counter, entropy value, or any other change in data) then the encrypted payload will also be unique in its encrypted state, thereby facilitating the comparison for identity with the prior encrypted payload while in its encrypted form.

In most cases, only one parameter associated with the state data needs to be compared with the same parameter in an earlier set of state data, and in many cases the parameter used for comparison is a parameter in its decrypted, or unencrypted, state. Thus, the data payload may be decrypted (or used in its original form, if there was no encryption in the first place) to allow comparison of one or more actual variables within the data. In such a case, any of the data values as described above may be the parameter to be compared. In one version, a current payload hash value is compared with a prior hash value. In other versions, the comparison parameter includes an appliance-applied timestamp, a data counter value, or any other data value which is expected to vary with each payload (such as by using several decimal places of precision for a temperature probe reading or other value, as described above).

The above comparison is performed by application software operating on the client device, such as the mobile device. When the application software determines that a parameter from a current data set is different from a corresponding parameter from the immediate-prior prior data set, it concludes that the received data set is new and thus the interaction with the appliance is operating appropriately. This does not necessarily mean that the appliance is actually connected to the server at any moment in time, and in fact it may not be connected depending on various factors such as timing of the polling or disruptions that might occur after transmission by the appliance. Instead, it means that when the client requested a fresh set of data, it received a set of data that was different from its most recent prior set of received data, and because of that difference the client concludes (correctly or incorrectly) that the data is current or at least that the client received what it asked for.

In some versions, at a next step 560 the application software may cause an indicator to be presented on the client device display which is indicative of the proper operation of the system, such as the indicator 204 shown on the display 202 in FIG. 1. The indicator may be, for example, a simple green dot or some other symbol or textual message indicative of the proper system operation. The message does not necessarily indicate that the appliance is connected to the server at any given time; rather, it generally indicates that when the client device received its most recent set of data, it was a fresh set as would be expected.

In some preferred versions, the client device may apply a timestamp to the set of received data, allowing it to keep track of the time at which it received a given set of data. This timestamp may be used when there is no appliance-applied timestamp, or may be applied in addition to the appliance timestamp. Optionally, the client application software may cause an indication representative of either of the timestamps to be presented on the display, with an indicator showing when the most recent set of data from the appliance was received.

In some instances, the comparison of data parameters may lead to the conclusion that the most recent set of data is the same as the prior set, and thus the conclusion from the comparison step 550 would be that the received data is a duplicate of the prior set of data. The most that is genuinely known from this comparison conclusion is that the data is the same; after a single matching comparison it generally would not be clear whether the appliance is connected or whether the system is otherwise operating properly. It may be that the transmission from the appliance and the polling interval at the client are misaligned, causing the same data to be received at the client application twice. Alternatively, it may be that the grill has become disconnected, though only briefly, through some glitch that may be quickly remedied through a reconnection protocol implemented at the appliance. In yet other cases, there may be a more important reason, such as a power outage or an ongoing disruption in the connection. In any of the foregoing cases, in the preferred version the display will not immediately indicate a disconnection (or otherwise display a symbol indicative of a problem or malfunction), but rather would maintain the same message indicative of a proper operation, at least initially. For a period of time thereafter, the client will preferably continue to receive sets of data from the server, and continue to perform the comparison step. If the appliance has lost its connection to the server, then the server would likely send the same previously-stored set of data to the client, repeatedly. If the client application repeatedly concludes that the newly received data set is the same as the immediate-prior received data set, then eventually it will change its display indicator to reflect that the system is not operating correctly, or that the appliance is no longer sending fresh data. In one version, the client will continue to compare data sets or parameters for three minutes after initially concluding that the data is the same, and will not display a system fault message unless the comparison produces a conclusion that the data is the same repeatedly for the course of the three minute interval. At that point, the indicator 204 on the display 202 will change to reflect the system error. This three minute fault-evaluation interval may be varied in other systems, so that it is either longer or shorter than three minutes.

In another example, the state data includes at least one parameter which is expected to vary in a predictable or known manner over time. For example, the parameter may be an auto-incrementing sequence that advances with each transmission. So long as the client device also knows the sequence and the formula for incrementing, the client device may be programmed to infer the value for the parameter which is expected to be contained within the next transmission of state data. Further where the sets of state data are received at the client device in accordance with a regular interval, the client device can infer an expected number of increments of the auto-incrementing sequence after the passage of a determined amount of time, and then to compare the received parameter against the inferred parameter to evaluate whether the set of recently received data is the expected one or whether the system seems to be operating incorrectly. Likewise, upon receipt of any set of state data, the client device may analyze the received sequence value to determine not merely whether it is different from its predecessor, but to also determine the number of times the sequence value has been incremented since the receipt of the prior set of state data. With this determination, the client device can also derive whether there was an unexpectedly long (or short) duration between transmissions, and can also determine whether any apparent transmissions were not received at the client device based on the current position in the sequence as compared with the last received position. In any of the foregoing cases, the client device may display an indicator to the user representative of either a proper state of operation or a fault such as an apparent disconnection.

The remote appliance control system can, in a preferred version, send instructions from the mobile device or client to the appliance, such as to increase or decrease a temperature or perform other functions. This functionality is standard (for the purposes of this invention) and is preferably incorporated into the mobile application. In such cases, the transmissions generally operate in reverse, with the client application preparing and sending instructions to the server where they are either passed along directly or briefly stored for later transmission upon request for any instructions from the appliance.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A system for remotely monitoring an appliance by a client device operating over a network, comprising:
an appliance controller coupled to the appliance and arranged for communication with the client device over the network, the appliance controller having an appliance processor configured to send state data regarding the appliance to the client device over the network, the state data including a parameter; and
an appliance memory accessible by the appliance processor; and
an application program stored on and operable by the client device to:
compare a first value of the parameter associated with a first set of state data received at the client device at a first time with a second value of the parameter associated with a second set of state data received at the client device at a second time later than the first time; and
when the operation of the application program determines that the first value of the parameter is not equal to the second value of the parameter, cause a client device display to present a first indicator indicating that the system is operating correctly.

2. The system of claim 1, wherein the parameter comprises a counter value.

3. The system of claim 1, wherein the parameter comprises a timestamp.

4. The system of claim 1, wherein the parameter comprises a hash value.

5. The system of claim 1, wherein the parameter comprises an entropy value.

6. The system of claim 1, wherein the state data is further encrypted at the appliance controller prior to transmission to the client device, and further wherein the parameter comprises the bit-by-bit content of the encrypted state data.

7. The system of claim 1, wherein the application program is further configured to cause the client device to present a second indicator when the application program determines that the first value of the parameter is equal to the second value of the parameter, the second indicator indicating that the system is not operating correctly.

8. The system of claim 67, wherein the application program is configured to cause the presentation of the second indicator only after repeated determinations that the first value of the parameter is equal to the second value of the parameter.

9. The system of claim 1, wherein the client device is a mobile phone.

10. A system for remotely monitoring over a network using a client device, comprising:
an appliance having an appliance subsystem and an appliance controller;
the appliance controller having an appliance processor, an appliance memory accessible by the appliance processor, and a transmitter arranged for communication with the client device over the network;
the appliance memory containing stored programming instructions operable by the processor to enable the processor to collect appliance state data, the appliance state data including data regarding the appliance subsystem, and to send the appliance state data via the transmitter to the client device over the network, the state data further including a parameter; and
an application program and operable by the client device to:
compare a first value of the parameter associated with a first set of appliance state data received at the client device at a first time with a second value of the parameter associated with a second set of appliance state data received at the client device at a second time later than the first time; and
when the operation of the application program determines that the first value of the parameter is not equal to the second value of the parameter, cause a client device user interface to present a first indicator indicating that the system is operating correctly.

11. The system of claim 10, wherein the client device is a mobile phone.

12. The system of claim 10, wherein the parameter comprises the data regarding the appliance subsystem.

13. The system of claim 10, wherein the parameter comprises a counter value.

14. The system of claim 10, wherein the parameter comprises a timestamp.

15. The system of claim 10, wherein the parameter comprises a hash value.

16. The system of claim 10, wherein the parameter comprises an entropy value.

17. The system of claim 10, wherein the state data is further encrypted at the appliance controller prior to transmission to the client device, and further wherein the parameter comprises the bit-by-bit content of the encrypted state data.

18. The system of claim 10, wherein the application program is further configured to cause the client device to present a second indicator when the application program determines that the first value of the parameter is equal to the second value of the parameter, the second indicator indicating that the system is not operating correctly.

19. The system of claim 18, wherein the application program is configured to cause the presentation of the second indicator only after repeated determinations that the first value of the parameter is equal to the second value of the parameter.

20. A system for remotely monitoring over a network using a client device, comprising:
an appliance having an appliance subsystem and an appliance controller;
the appliance controller having an appliance processor, an appliance memory accessible by the appliance processor, and a transmitter arranged for communication with the client device over the network;
the appliance memory containing stored programming instructions operable by the processor to enable the processor to collect appliance state data, the appliance state data including data regarding the appliance subsystem, and to send the appliance state data via the transmitter to the client device over the network, the state data further including a parameter; and
an application program and operable by the client device to:
compare a first value of the parameter associated with a first set of appliance state data received at the client device at a first time with an inferred expected value of the parameter; and
when the operation of the application program determines that the first value of the parameter is different from the inferred expected value of the parameter, cause a client device user interface to present a first indicator indicating that the system is operating incorrectly.

21. The system of claim 20, wherein the first indicator is presented on the user interface only after a predetermined time following the determination that the first value of the parameter is different than to the inferred expected value.

22. The system of claim 20, wherein the parameter is an incrementing sequence value.

23. The system of claim 20, wherein the application program is operable by the client device to compare a subsequent set of appliance state data having a second value of the parameter and received at the client device at a second time with a subsequent inferred expected value of the parameter, and to cause the client device to present a second indicator indicating that the system is operating correctly when the operation of the application program determines that the subsequent inferred expected value is consistent with the second value of the parameter.
